(19) United States
(12) Patent Application Publication
(10) Pub. No.: US 2009/0249574 A1
(43) Pub. Date: Oct. 8, 2009

(54) Painting roller

(76) Inventor: Hsu Hsiu-Kwei LIU, Taichung (TW)

Correspondence Address: TROXELL LAW OFFICE PLLC, SUITE 1404, 5205 LEESBURG PIKE, FALLS CHURCH, VA, 22041, US

(21) Appl. No.: 12/078,623

(22) Filed: Apr. 2, 2008

(51) Int. Cl. B05C 17/02

(52) U.S. Cl. 15/230.11

(57) ABSTRACT

A painting roller includes a fixed and a movable core, on which a roller cover is mounted. A compression spring is put on a rear end of the fixed core. The movable core is slidably received in the fixed core and may be extended from a front end of the fixed core by different length and then held to that position. A pull cord is extended through the fixed core to connect an end to a switch provided on a handle of the painting roller. When the switch is pushed, the pull cord is pulled to drive a rotor toward the compression spring to compress the latter, so the rotor is separated from a clamper to allow convenient mounting and dismounting of the roller cover to and from the painting roller.

### FIELD OF THE INVENTION

The present invention relates to a printing roller, and more particularly to a painting roller that has a fixed and a movable core to enable adjustment of an overall length of the two cores for supporting roller covers of different sizes, and allows automatic dismounting of a roller cover from the painting roller.

### BACKGROUND OF THE INVENTION

There are various types of painting rollers available in the market. These conventional painting rollers include a core having a fixed length. Therefore, a plurality of painting rollers having different core lengths must be prepared for roller covers of different sizes. It is apparently inconvenient and not economical for a user to prepare so many printing rollers.

Moreover, most conventional painting rollers do not allow automatic dismounting of the roller cover from the painting roller. It is inconvenient and time-consuming for a user to manually dismount the roller cover, and the user's hands are easily smudged by the wet paint remained on the roller cover.

It is therefore tried by the inventor to develop an improved painting roller that could be used with differently sized roller covers and allows automatic dismounting of the roller cover from the painting roller.

### SUMMARY OF THE INVENTION

A primary object of the present invention is to provide a painting roller that could be used with differently sized roller covers.

Another object of the present invention is to provide a painting roller that allows automatic dismounting of the roller cover from the painting roller.

To achieve the above and other objects, the painting roller according to the present invention includes a handle, a roller frame, a cap, a compression spring, a rotor, a clamper, a fixed core, a movable core, a pull cord, a cord holder, a crossbar, an end cap, a plurality of retaining rings, and a locating pin. The compression spring is put on the fixed core to locate in the cap, which is connected to a rear end of the fixed core. The movable core is slidably received in the fixed core and may be extended from or retracted into a front end of the fixed core and then held to that position via a spring leaf mounted in the movable core for engaging with different locating holes provided on the fixed core. Moreover, the pull cord has an end extended through the fixed core to connect to a switch provided on the handle. When the switch is pushed, the pull cord and the cord holder connected to another end of the pull cord are pulled to drive the crossbar to push the rotor and compress the compression spring, so that the rotor is separated from the clamper to allow convenient mounting and dismounting of the roller cover to and from the painting roller.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a painting roller according to the present invention;

FIGS. 2 to 4 show the manner of assembling the painting roller of the present invention;

FIG. 5 is an assembled perspective view of the painting roller of the present invention with a roller cover mounted thereto;

FIGS. 6 and 7 show the manner of dismounting the roller cover from the painting roller; and

FIG. 8 shows the manner of extending an overall length of a core of the painting roller of the present invention.

### DETAILED DESCRIPTION OF THE PREFERRED EMBODIMENTS

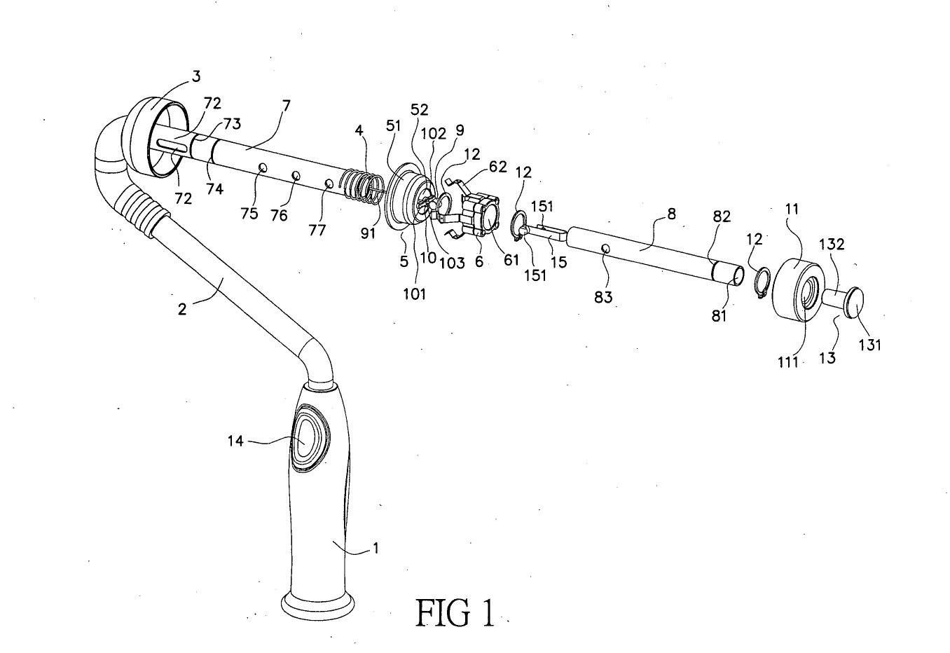

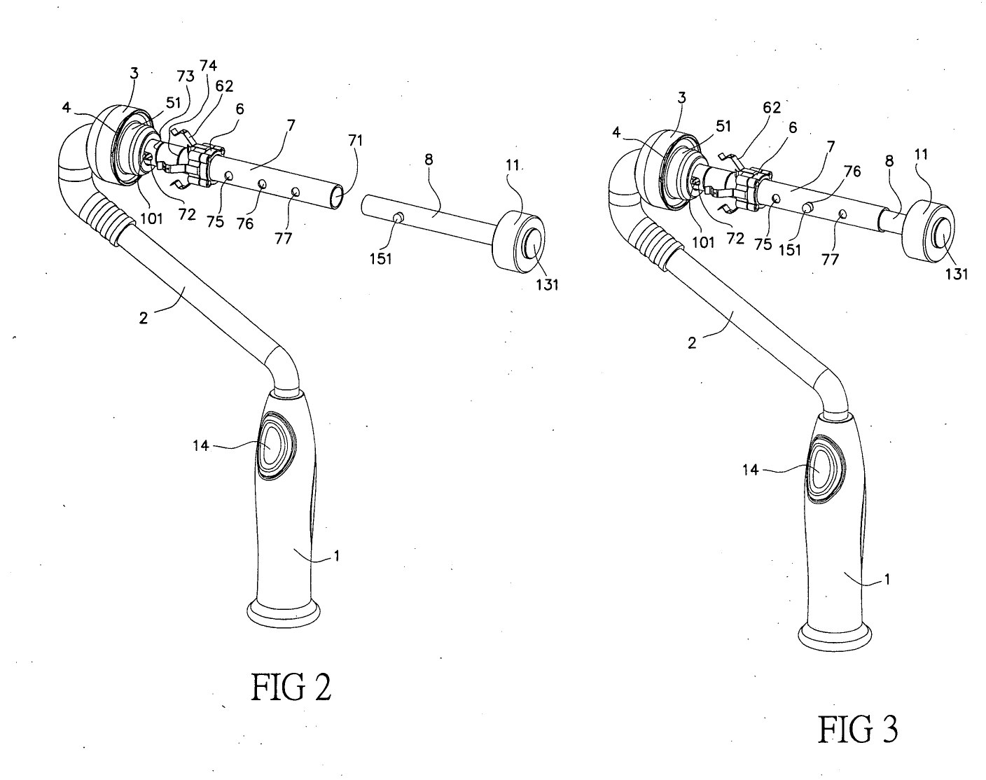

Please refer to FIG. 1 that is an exploded perspective view of a painting roller according to the present invention, and to FIGS. 2 to 4 that show the manner of assembling the painting roller of the present invention. As shown, the painting roller of the present invention includes a handle 1, a roller frame 2, a cap 3, a rotor 5, a clamper 6, a fixed core 7, and a movable core 8.

The rotor 5 and the clamper 6 together with a compression spring 4, a cord holder 9, a pull cord 91, and a crossbar 10 are assembled to the fixed core 7. The compression spring 4 is mounted around the fixed core 7 and located in the cap 3.

The fixed core 7 internally defines an axially extended bore 71, and is provided near a rear end closer to the cap 3 with two diametrically opposite and axially extended symmetrical long slots 72 communicable with the axial bore 71, on an outer surface in front of the long slots 72 with two axially spaced annular grooves 73, 74, and within a section in front of the two annular grooves 73, 74 with plural spaced pairs of diametrically opposite locating holes 75, 76, 77 communicable with the axial bore 71.

The crossbar 10 has two opposite ends 101, 102, and is provided with a centered through hole 103. The pull cord 91 has a first end connected to the cord holder 9, and a second end sequentially extended through the central hole 103 on the crossbar 10 and the axial bore 71 of the fixed core 7 to a push-button switch 14 provided on the handle 1. The crossbar 10 is disposed in the axial bore 71 with the two opposite ends 101, 102 separately projected from the two diametrically opposite long slots 72 on the fixed core 7.

The rotor 5 includes a cylindrical portion 51 that internally defines an axially extended bore 52, via which the fixed core 7 may be extended for the rotor 5 to mount on the fixed core 7. The rotor 5 mounted on the fixed core 7 is located behind the crossbar 10 with a rear end surface of the rotor 5 abutted on a front end of the compression spring 4 in the cap 3.

The clamper 6 internally defines an axially extended bore 61 via which the fixed core 7 is extended for the clamper 6 to rotatably mount on the fixed core; and is provided at a rear end with a plurality of rearward extended elastic claws 62. The clamper 6 rotatably mounted on the fixed core 7 is held between the two spaced annular grooves 73, 74 by setting two retaining rings 12 in the two annular grooves 73, 74, such that the rearward extended elastic claws 62 of the clamper 6 are normally in contact with an outer surface of the cylindrical portion 51 of the rotor 5 to clamp the latter.

The movable core 8 internally defines an axially extended bore 81, and has an outer diameter slightly smaller than the axial bore 71 of the fixed core 7, and can therefore be slidably received in the axial bore 71 of the fixed core 7. The movable core 8 is provided on an outer surface near a front end thereof with an annular groove 82, and near a rear end thereof with two diametrically opposite through holes 83 communicable with the axial bore 81.

An end cap 11, a locating pin 13, and a U-shaped spring leaf 15 are assembled to the movable core 8.

The end cap 11 has an outer diameter the same as that of the cylindrical portion 51 of the rotor 5, and internally defines an axially extended bore 111, via which the movable core 8 may be extended for the end cap 11 to rotatably mount on the movable core 8.

The locating pin 13 has an expanded head 131 diametrically larger than the axial bore 111 of the end cap 11, and a shank 132 diametrically slightly smaller than the axial bore 81 of the movable core 8.

The end cap 11 mount on the movable core 8 is held between the annular groove 82 and the front end of the movable core 8 by setting a retaining ring 12 in the annular groove 82 and inserting the locating pin 13 through the axial bore 111 of the end cap 11 into the axial bore 81 of the movable core 8. With the shank 132 of the locating pin 13 received in the axial bore 81 in a tight-fit relation, the end cap 11 is rotatably held to the front of the movable core 8 between the retaining ring 12 in the annular groove 82 and the expanded head 131 of the locating pin 13.

The U-shaped spring leaf 15 has two spaced free ends. A boss 151 is outward extended from an outer side of each of the two free ends of the U-shaped spring leaf 15. The U-shaped spring leaf 15 is disposed in the axial bore 81 of the movable core 8 with the two bosses 151 elastically projected from the two opposite through holes 83 on the movable core 8.

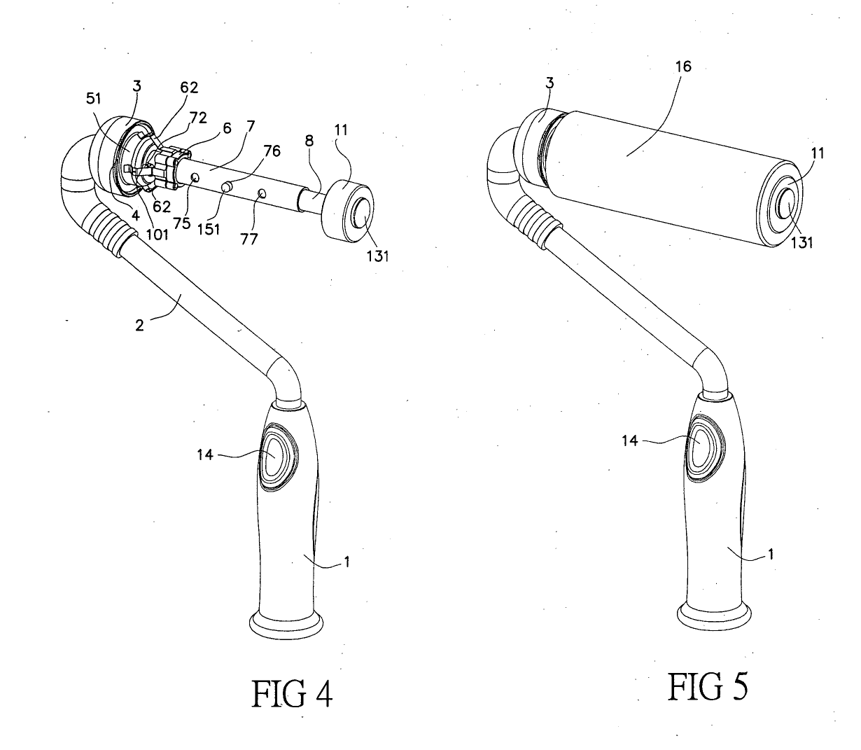

FIG. 4 shows the painting roller of the present invention in a fully assembled state, and FIG. 5 shows the assembled painting roller of the present invention with a roller cover 16 mounted on the fixed core 7 between the cap 3 and the end cap 11.

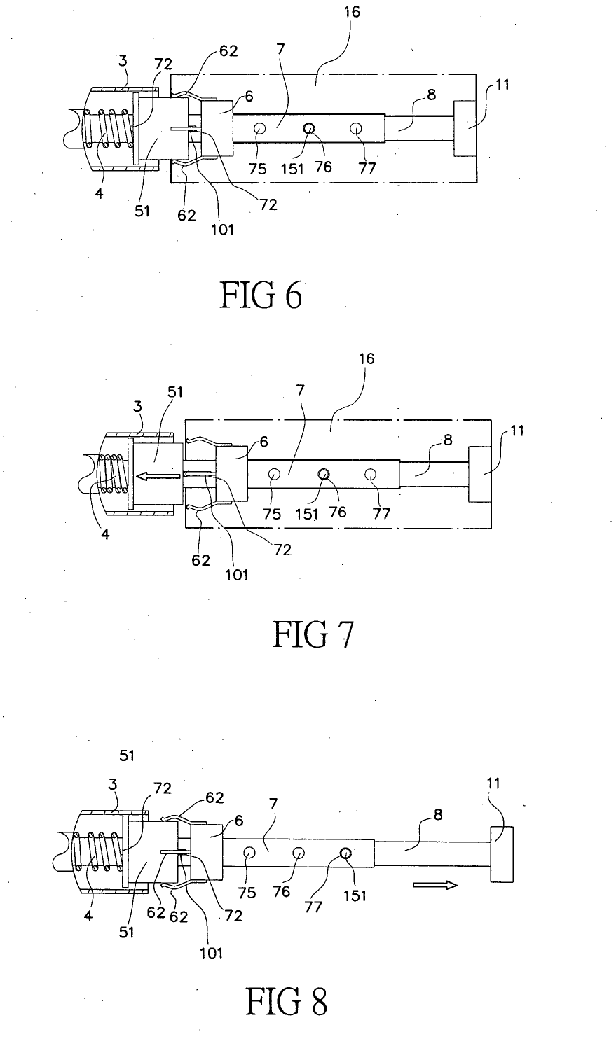

Please refer to FIGS. 6 and 7. When it is desired to dismount the roller cover 16 from the painting roller of the present invention, simply push the switch 14 on the handle 1. At this point, the pull cord 91 is pulled to drive the cord holder 9 to push the crossbar 10 rearward along the two long slots 72. At this point, the two opposite ends 101, 102 of the crossbar 10 projected from the two long slots 72 are pressed against a front end of the cylindrical portion 51 of the rotor 5, so that the rotor 5 is driven to move rearward to separate from the claws 62 of the clamper 6 and compress the compression spring 4 located in the cap 3 and behind the rotor 5, and the roller cover 16 can be automatically dismounted from the painting roller.

Please refer to FIG. 8. When it is desired to adjust an overall length of the fixed and movable cores 7, 8, simply radially inward push the two bosses 151 of the U-shaped spring leaf 15 for them to retract into the axial bore 71 of the fixed core 7, and pull the movable core 8 outward until the two bosses 151 are elastically sprung outward into one desired pair of locating holes 75, 76, or 77. At this point, the movable core 8 is held in place to project from the fixed core 7 by a desired length. In the illustrated embodiment, the bosses 151 are moved from the locating holes 76 to the locating holes 77 to increase the length by which the movable core 8 is projected from the front end of the fixed core 7.

What is claimed is:

1. A printing roller, comprising a handle, a roller frame, a cap, a clamper, a fixed core, and a movable core.

2. The printing roller as claimed in claims 1, further comprising a compression spring, a pull cord, a cord holder, a crossbar, and a rotor, which along with the clamper are assembled to the fixed core.

3. The printing roller as claimed in claims 2, wherein the compression spring is mounted on the fixed core near a rear end thereof to locate in the cap.

4. The printing roller as claimed in claims 3, wherein the fixed core internally defines an axially extended bore, and is provided near the rear end with two symmetrical and diametrically opposite long slots communicable with the axial bore.

5. The printing roller as claimed in claims 4, wherein the fixed core is provided in front of the two symmetrical long slots with two axially spaced annular grooves.

6. The printing roller as claimed in claims 5, wherein the fixed core is provided in front of the two axially spaced annular grooves with plural axially spaced pairs of symmetrical locating holes communicable with the axial bore of the fixed core.

7. The printing roller as claimed in claims 6, wherein the crossbar has two opposite ends and is provided at a center with a through hole.

8. The printing roller as claimed in claims 7, wherein the pull cord has a first end connected to the cord holder, and a second end rearward extended through the centered through hole on the crossbar and the axial bore of the fixed core to a push-button switch provided on the handle.

9. The printing roller as claimed in claims 8, wherein the crossbar is located in the axial bore of the fixed core with the two opposite ends outward projected from the two symmetrical long slots near the rear end of the fixed core.

10. The printing roller as claimed in claims 9, wherein the two opposite ends of the crossbar are pressed against a front end of the rotor.

11. The printing roller as claimed in claims 10, wherein the rotor includes a front cylindrical portion and internally defines an axial bore, through which the fixed core is extended; and the rotor has a rear end surface abutted on a front end of the compression spring.

12. The printing roller as claimed in claims 11, wherein the clamper internally defines an axially extended bore, and is provided at a rear end with a plurality of rearward extended elastic claws; the clamper being rotatably mounted on the fixed core between the two axially spaced annular grooves by setting two retaining rings in the two annular grooves, such that the rearward extended elastic claws of the clamper are normally in contact with an outer surface of the cylindrical portion of the rotor to clamp the rotor.

13. The printing roller as claimed in claims 12, further comprising a generally U-shaped spring leaf, an end cap, and a locating pin assembled to the movable core.

14. The printing roller as claimed in claims 13, wherein the movable core has an outer diameter slightly smaller than the axial bore of the fixed core, and can therefore be slidably received in the axial bore of the fixed core.

15. The printing roller as claimed in claims 14, wherein the movable core is provided on an outer surface near a front end thereof with an annular groove.

16. The printing roller as claimed in claims 15, wherein the movable core is provided near a rear end thereof with two diametrically opposite through holes communicating with an axial bore of the movable core.

17. The printing roller as claimed in claims 15, wherein the end cap has an outer diameter the same as that of the cylindrical portion of the rotor, and internally defines an axial bore, via which the movable core is extended; and the end cap being held to the front end of the movable core by setting a retaining ring in the annular groove provided thereat.

18. The printing roller as claimed in claims 16, wherein the U-shaped spring leaf has two spaced free ends, and a boss is outward extended from an outer side of each of the two free ends of the U-shaped spring leaf; and the U-shaped spring leaf being disposed in the axial bore of the movable core with the two bosses elastically projected from the two opposite through holes on the movable core.

19. The printing roller as claimed in claims 17, wherein the locating pin has an expanded head diametrically larger than the axial bore of the end cap, and a shank diametrically slightly smaller than the axial bore of the movable core; whereby when the shank of the locating pin is inserted through the axial bore of the end cap to tight-fit in the axial bore of the movable core, the end cap held to the front end of the movable core is stopped by the expanded head of the locating pin from separating from the movable core.
